(19) United States
(12) Patent Application Publication
(10) Pub. No.: US 2018/0150220 A1
(43) Pub. Date: May 31, 2018

(54) SYSTEM AND METHOD FOR IMPROVING STORAGE DEVICE I/O PERFORMANCE

(71) Applicant: Samsung Electronics Co., Ltd., Suwon-si (KR)

(72) Inventors: Ramaraj N. PANDIAN, Cupertino, CA (US); Vaibhav NIPUNAGE, San Jose, CA (US); Prashant PRABHU, Cupertino, CA (US); Jason MARTINEAU, San Jose, CA (US)

(21) Appl. No.: 15/456,462

(22) Filed: Mar. 10, 2017

Related U.S. Application Data
(60) Provisional application No. 62/426,421, filed on Nov. 25, 2016.

(51) Int. Cl. G06F 3/06

(52) U.S. Cl. CPC G06F 3/061; G06F 3/0683; G06F 3/0659; G06F 3/0656

(57) ABSTRACT

Inventive aspects include an input/output (I/O) interceptor logic section having an I/O interface coupled with a storage stack. The I/O interface may intercept write I/Os, read I/Os, and flush requests from an application. Write holding buffers associated with different kinds of non-volatile storage devices may store the write I/Os. A re-order logic section may change an order of the write I/Os, and combine the re-ordered write I/Os into a combined write I/O. A dynamic heterogeneous flush control logic section may receive the flush requests from the I/O interface, communicate write I/O completion of the write I/Os to the application without write I/Os being committed to the non-volatile storage devices, and cause the combined write I/O to be written to the non-volatile storage device responsive to a dynamic flush threshold, a threshold amount of data being accumulated, or an expiration of a predefined time period.

### BACKGROUND

The present inventive concepts relate to storage device input/output (I/O) techniques, and more particularly, to a system and method for improving storage device I/O performance using an input/output (I/O) interceptor with dynamic heterogeneous flush control logic embedded within a storage stack of a computerized device such as a server.

Performance demands on computing devices such as enterprise servers are increasing. While processor and networking performance such computer server devices have steadily improved, the local storage stack within such mobile devices has not advanced as quickly. Computers today often have multiple heterogeneous storage devices within or otherwise associated with a server or server rack. Flush requests that are commonly used to ensure data consistency have become barriers to performance because I/Os are blocked during the flush command, and there is no distinction made between different kinds of storage devices, which further impacts the overall performance of these systems. Consequently, the storage stack and associated local storage devices of such server systems have become a performance bottleneck. Embodiments of the inventive concept address these and other limitations in the prior art.

### BRIEF SUMMARY

Embodiments may include an input/output (I/O) interceptor logic section. The I/O interceptor logic section may include an I/O interface communicatively coupled with a storage stack and configured to intercept a plurality of write I/Os and a plurality of flush requests from an application. The I/O interceptor logic section may include a plurality of write holding buffers each associated with a corresponding non-volatile storage device from among a plurality non-volatile storage devices, wherein each of the write holding buffers is configured to receive a subset of the plurality of write I/Os from the I/O interface and to store the subset of write I/Os. The I/O interceptor logic section may include a dynamic heterogeneous flush control logic section configured to receive the plurality of flush requests from the I/O interface, to communicate write I/O completion of the plurality of write I/Os to the application without the plurality of write I/Os having been written from the plurality of write holding buffers to the corresponding non-volatile storage device from among the plurality of non-volatile storage devices.

Embodiments man include an input/output (I/O) interceptor logic section comprising an I/O interface communicatively coupled with a storage stack and configured to intercept a plurality of write I/Os and a plurality of flush requests from an application. The I/O interceptor logic section may include a plurality of write holding buffers configured to receive the plurality of write I/Os from the I/O interface and to store the plurality of write I/Os. Each of the write holding buffers may include a multiple-buffer holding queue configured to hold a plurality of write holding sub-buffers. The I/O interceptor logic section may include a dynamic heterogeneous flush control logic section configured to receive the plurality of flush requests from the I/O interface, to communicate write I/O completion of the plurality of write I/Os to the application without the plurality of write I/Os having been written to a plurality of non-volatile storage devices, and to cause the multiple-buffer holding queue to empty the plurality of write I/Os from the plurality of write holding sub-buffers to the plurality of non-volatile storage devices responsive to a number of flush requests from among the plurality of flush requests being equal to or greater than a dynamic flush threshold.

Embodiments may include a computer-implemented method for intercepting input/outputs (I/Os) from an application using an I/O interceptor logic section, the method comprising intercepting, by an I/O interface of the I/O interceptor logic section, a plurality of write I/Os and a plurality of flush requests from the application. The method may include storing, by a plurality of write holding buffers, the plurality of write I/Os intercepted by the I/O interface. The method may include receiving, by a dynamic heterogeneous flush control logic section, the plurality of flush requests from the I/O interface. The method may include communicating, by the dynamic heterogeneous flush control logic section, write I/O completion of the plurality of write I/Os to the application without the plurality of write I/Os having been written to a plurality of non-volatile storage devices, wherein each of the write holding buffers is associated with a corresponding one of the non-volatile storage devices. The method may include causing, by the dynamic heterogeneous flush control logic section, the write I/Os to be written to the plurality of non-volatile storage devices responsive to a number of flush requests from among the plurality of flush requests being equal to or greater than a dynamic flush threshold.

### BRIEF DESCRIPTION OF THE DRAWINGS

The foregoing and additional features and advantages of the present inventive principles will become more readily apparent from the following detailed description, made with reference to the accompanying figures, in which:

FIG. 1A is an example block diagram of a system stack including a host, physical hardware devices, and an I/O interceptor logic section, in accordance with embodiments of the inventive concept.

FIG. 1B is an example block diagram of a system stack including a host including an I/O interceptor logic section, and physical hardware devices including non-volatile write holding buffers, in accordance with embodiments of the inventive concept.

FIG. 2A is an example block diagram of the I/O interceptor logic section of FIG. 1A, including multiple temporary write holding buffers, each associated with a different kind of physical non-volatile storage device, or a different connection thereto, in accordance with embodiments of the inventive concept.

FIG. 2B is an example block diagram of the I/O interceptor logic section of FIG. 1B, and multiple non-volatile write holding buffers, each associated with a different kind of physical non-volatile storage device, or a different connection thereto, in accordance with embodiments of the inventive concept.

FIG. 3 is an example diagram of various components of the system stack of FIG. 1A, including a series of events relative to time, in accordance with embodiments of the inventive concept.

FIG. 4 is an example diagram of a re-order logic section of the I/O interceptor logic section and a write holding buffer of the I/O interceptor logic section of FIGS. 1A and 1B in accordance with embodiments of the inventive concept.

FIG. 5 an example diagram of a re-order logic section of the I/O interceptor logic section and a re-mapped memory section of the I/O interceptor logic section of FIGS. 1A and 1B in accordance with embodiments of the inventive concept.

FIG. 6 is an example diagram of an intelligent flush control logic section of the I/O interceptor logic section and a write holding buffer of the I/O interceptor logic section of FIGS. 1A and 1B in accordance with embodiments of the inventive concept.

FIG. 7 is another example diagram of an intelligent flush control logic section of the I/O interceptor logic section and a write holding buffer of the I/O interceptor logic section of FIGS. 1A and 1B in accordance with embodiments of the inventive concept.

FIG. 8 is a schematic diagram of a server rack including the I/O interceptor logic section of FIGS. 1A and 1B, in accordance with embodiments of the inventive concept.

FIG. 9 is a schematic diagram of a computer server including the I/O interceptor logic section of FIGS. 1A and 1B, in accordance with embodiments of the inventive concept.

FIG. 10 is a flow diagram illustrating a technique for intercepting I/Os from an application using an I/O interceptor logic section in accordance with embodiments of the inventive concept.

FIG. 11 is a flow diagram illustrating another technique for intercepting I/Os from an application using an I/O interceptor logic section in accordance with embodiments of the inventive concept.

FIG. 12 is a block diagram of a computing system including an I/O interceptor logic section according to embodiments of the inventive concept as disclosed herein.

### DETAILED DESCRIPTION

Reference will now be made in detail to embodiments of the inventive concept, examples of which are illustrated in the accompanying drawings. In the following detailed description, numerous specific details are set forth to enable a thorough understanding of the inventive concept. It should be understood, however, that persons having ordinary skill in the art may practice the inventive concept without these specific details. In other instances, well-known methods, procedures, components, circuits, and networks have not been described in detail so as not to unnecessarily obscure aspects of the embodiments.

It will be understood that, although the terms first, second, etc. may be used herein to describe various elements, these elements should not be limited by these terms. These terms are only used to distinguish one element from another. For example, a first power switch cell could be termed a second power switch cell, and, similarly, a second power switch cell could be termed a first power switch cell, without departing from the scope of the inventive concept.

The terminology used in the description of the inventive concept herein is for the purpose of describing particular embodiments only and is not intended to be limiting of the inventive concept. As used in the description of the inventive concept and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The components and features of the drawings are not necessarily drawn to scale.

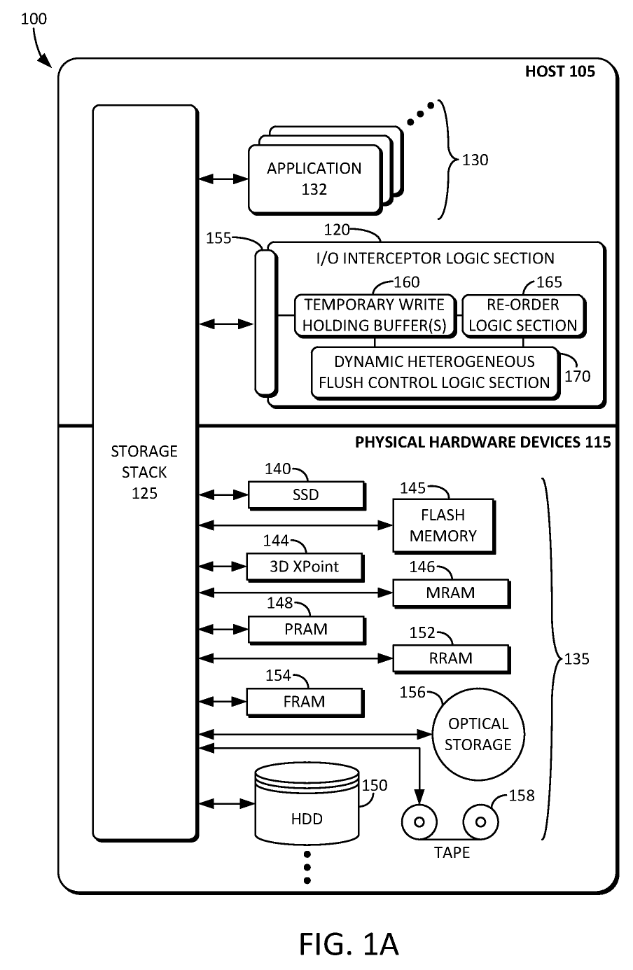

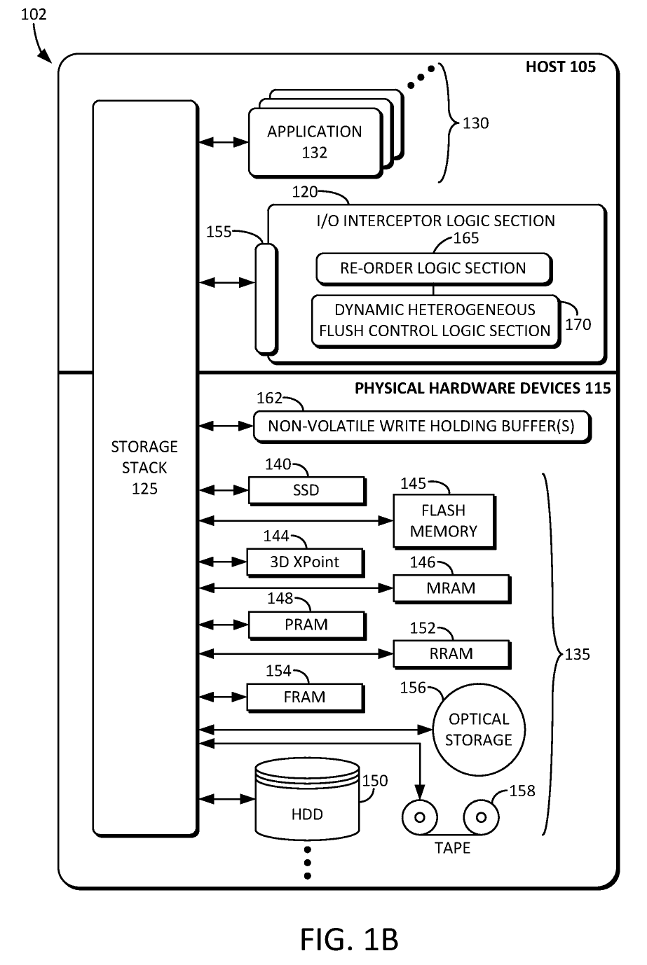

FIG. 1A is an example block diagram of a system stack 100 including a host 105 and physical hardware devices 115. In accordance with embodiments of the inventive concept, an input/output (I/O) interceptor logic section 120 may be operable within the host 105. It will be understood that in an alternative embodiment, the I/O interceptor logic section 120 may be instantiated within a physical layer of the storage stack 125, or within different sections or spaces of any suitable computing device. The system stack 100 may be included, for example, in a computer server, a computer workstation, a rack of computer servers, a laptop, another suitable computer, or the like, as further described below.

As shown in FIG. 1A, the system stack 100 may include a storage stack 125. The storage stack 125 may facilitate sending and receiving of input/outputs (I/Os) between one or more applications 130 of the host 105, such as application 132, and one or more non-volatile storage devices 135 of the physical hardware devices 115. The one or more non-volatile storage devices 135 may include a solid state drive (SSD) 140, a flash memory 145, a 3D XPpoint memory 144, a magnetoresistive random-access memory (MRAM) 146, a phase change memory (PRAM) 148, a resistive random access memory (RRAM) 152, a ferroelectric random access memory (FRAM) 154, an optical storage 156, a tape device 158, a hard disk drive 150, or the like.

The I/O interceptor logic section 120 may include an I/O interface 155, one or more temporary write holding buffers 160, a re-order logic section 165, and a dynamic heterogeneous flush control logic section 170. The I/O interface 155 may be communicatively coupled with the storage stack 125. The I/O interceptor logic section 120 may intercept all I/Os, including flush requests, from the application (e.g., 132). For example, the I/O interface 155 may intercept write I/Os, read I/Os, and flush requests from the application (e.g., 132). The temporary write holding buffers 160 may receive the write I/Os from the I/O interface 155 and may store the write I/Os. The temporary holding buffers 160 may be pre-allocated from free system memory.

The re-order logic section 165 may be communicatively coupled to the temporary write holding buffers 160. The re-order logic section 165 may change an order of the write I/Os stored in each of the temporary write holding buffers 160. The re-order logic section 165 may combine the re-ordered write I/Os into a combined write I/O for each of the temporary write holding buffers 160, as further described below. The dynamic heterogeneous flush control logic section 170 may receive the flush requests from the I/O interface 155. The dynamic heterogeneous flush control logic section 170 may communicate write I/O completion of the write I/Os to the application (e.g., 132) without the write I/Os actually having been written to any of the one or more non-volatile storage devices 135.

From the application's perspective, the write I/O has completed, while in reality, the write I/O has not been committed to non-volatile storage at this point in time. In other words, the dynamic heterogeneous flush control logic section 170 may communicate write I/O completion of the write I/Os to the application 132 before the write I/Os have actually been written to any of the one or more non-volatile storage devices 135. The dynamic heterogeneous flush control logic section 170 may cause the combined write I/O to be written to corresponding non-volatile storage devices 135 responsive to a number of flush requests being equal to or greater than a dynamic flush threshold, or other criteria, as also further described below.

FIG. 1B is an example block diagram of a system stack 102 including a host 105 including an I/O interceptor logic section 120, and physical hardware devices 115 including non-volatile write holding buffers 162, in accordance with embodiments of the inventive concept. The system stack 102 is similar to the system stack 100 illustrated in FIG. 1A, with the notable difference that the write holding buffers 162 are instantiated on non-volatile memory devices, and exist among the physical hardware devices 115. For example, the non-volatile write holding buffers 162 can reside on one or more physical non-volatile storage devices, preferably fast ones such as PRAM, MRAM, or 3D XPoint devices. In other words, the PRAM, MRAM, or 3D XPoint devices can in effect be used as replacements for DRAM.

The attributes of the non-volatile storage devices used to hold the buffers 162 can be used to determine dynamic flushes, as further described below. For example, using non-volatile devices such as PRAM, MRAM, or 3D XPoint devices to incorporate the write holding buffers 162, there is less risk of data loss, and in some cases differing/higher capacity. Consequently, the write holding buffers 162 can be flushed less often. Even though the physical non-volatile devices that store the write holding buffers 162 are among the physical hardware devices 115, the logical control of the non-volatile write holding buffers 162 may remain with the I/O interceptor logic section 120, which is instantiated on the host 105.

In some embodiments, the physical devices (e.g., PRAM, MRAM, or 3D XPoint memory devices) that store the write holding buffers 162 need not be the same as the physical devices 135 used as final flush targets. In some embodiments, the physical devices (e.g., PRAM, MRAM, or 3D XPoint memory devices) that store the write holding buffers 162 can be the same as at least some of the physical devices 135 used as final flush targets, in a hierarchical tiered system.

The detailed description is not repeated for components having the same reference numerals as the system stack 100 described above.

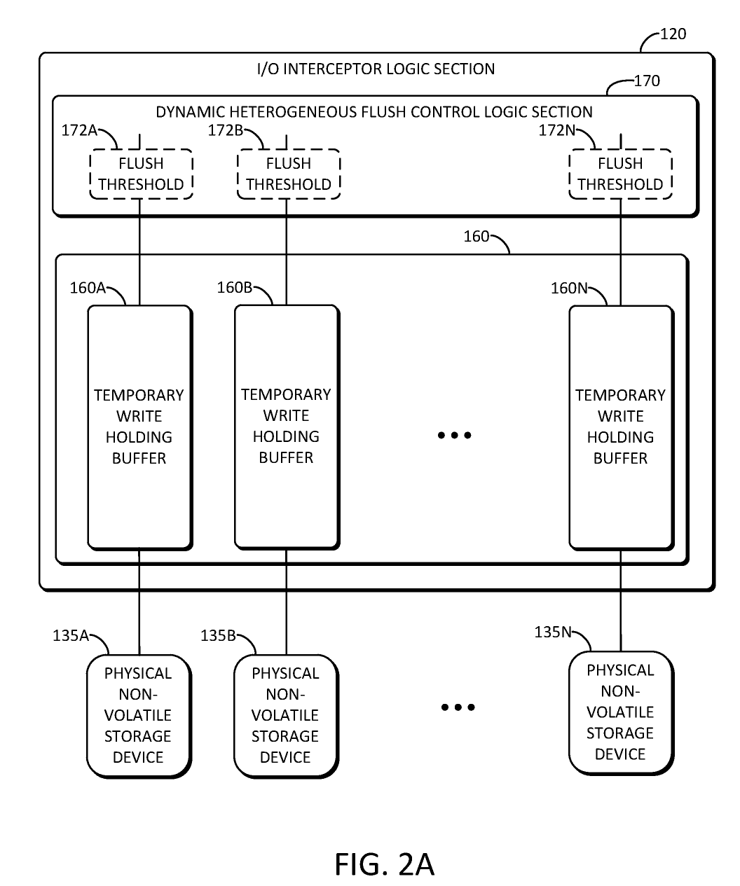

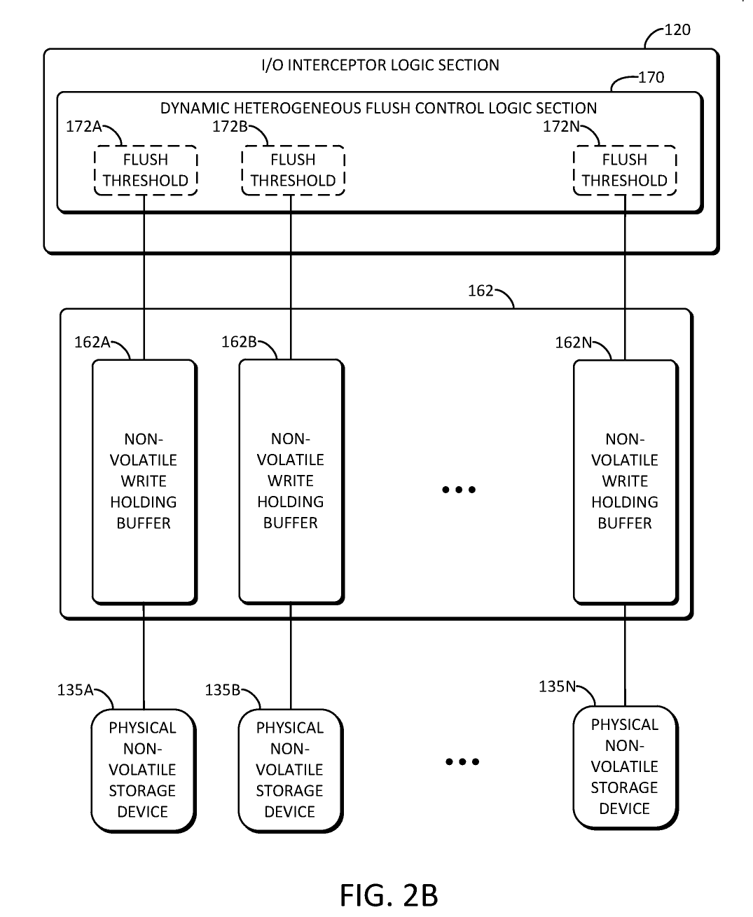

FIG. 2A is an example block diagram of the I/O interceptor logic 120 section of FIG. 1A, including multiple write holding buffers (e.g., 160A, 160B, through 160N), each associated with a different kind of physical non-volatile storage device (e.g., 135A, 135B, through 135N), in accordance with embodiments of the inventive concept. Alternatively or in addition, the temporary write holding buffers (e.g., 160A, 160B, through 160N) may each be associated with a similar or same kind of physical non-volatile storage device (e.g., where 135A, 135B, through 135N are non-volatile storage devices that are similar or of the same kind), but that are connected in different ways. For example, a connection to one non-volatile storage device (e.g., 135A) may involve an Ethernet connection, whereas a connection to another similar kind of non-volatile storage device (e.g., 135B) may involve a flash over PCIe connection.

In some embodiments, each of the temporary write holding buffers (e.g., 160A, 160B, through 160N) may be associated with or otherwise coupled to a corresponding non-volatile storage device (e.g., 135A, 135B, through 135N). In addition, each of the temporary write holding buffers (e.g., 160A, 160B, through 160N) may receive a subset of the write I/Os from the I/O interface 155 and temporarily store the subset of write I/Os. The dynamic heterogeneous flush control logic section 170 may receive flush requests from the I/O interface 155. The dynamic heterogeneous flush control logic section 170 may communicate write I/O completion of the write I/Os to the application (e.g., 132 of FIG. 1A) without the write I/Os having been written from the temporary write holding buffers (e.g., 160A, 160B, through 160N) to the corresponding non-volatile storage device (e.g., 135A, 135B, through 135N).

In some embodiments, each of the non-volatile storage devices (e.g., 135A, 135B, through 135N) may be of a different kind, i.e., of a heterogeneous nature. For example, the non-volatile storage devices (e.g., 135A, 135B, through 135N) may correspond to the various different kinds of non-volatile storage devices 135 described above with reference to FIG. 1A. Consequently, each of the non-volatile storage devices (e.g., 135A, 135B, through 135N) may have characteristics that are different from each other, including characteristics such as capacity, block size, local caching characteristics, read or write latency, optimal burst size, throughput, or the like. In some embodiments, each of the non-volatile storage devices (e.g., 135A, 135B, through 135N) may be of a same or similar kind, but with different types of connections, such as Ethernet or PCIe. The different types of connections can cause different operating characteristics such as read or write latency, optimal burst size, throughput, or the like.

The dynamic heterogeneous flush control logic section 170 may dynamically vary a flush threshold, as further described in detail below, dependent on which kind of non-volatile storage device the write I/Os are being sent to, and/or dependent on which kind of connection the write I/Os are being sent over. Put differently, the dynamic flush threshold may be dependent on a kind of the corresponding non-volatile storage device or connection to which the combined write I/O is sent. In other words, a flush threshold can be variable based on the characteristics of the underlying storage or connection, including characteristics of underlying cache and/or the characteristics of the underlying final physical storage device. The rate of actual committed flushes may be varied depending on the type of underlying physical storage to which the write I/Os and flushes are being sent. The actual committed flushes may be varied from drive to drive, or from one non-volatile storage device to another.

The dynamic heterogeneous flush control logic section 170 may include a plurality of flush thresholds (e.g., 172A, 172B, through 172N) each associated with a corresponding one of the non-volatile storage devices (e.g., 135A, 135B, through 135N). In some embodiments, each of the flush thresholds (e.g., 172A, 172B, through 172N) is different relative to each other, and based on the kind of the underlying non-volatile storage device or connection with which it is associated. The dynamic heterogeneous flush control logic section 170 may cause the write I/Os from each of the temporary write holding buffers (e.g., 160A, 160B, through 160N) to be written to the corresponding non-volatile storage device (e.g., 135A, 135B, through 135N) responsive to a number of flush requests being equal to or greater than a corresponding flush threshold (e.g., 172A, 172B, through 172N).

The temporary write holding buffers 160 may include a first temporary write holding buffer 160A, a second temporary write holding buffer 160B, and a third temporary write holding buffer 160N, and so forth. The non-volatile storage devices 135 can include a first non-volatile storage device 135A, a second non-volatile storage device 135B, a third non-volatile storage device 135N, and so forth. The first temporary write holding buffer 160A may be associated with the first non-volatile storage device 135A. The second temporary write holding buffer 160B may be associated with the second non-volatile storage device 135B. The third temporary write holding buffer 160C may be associated with the third non-volatile storage device 135N, and so forth.

The dynamic heterogeneous flush control logic section 170 may cause the subset of write I/Os from the first temporary write holding buffer 160A to be written to the first non-volatile storage device 135A responsive to a number of flush requests associated with the first non-volatile storage device 135A being equal to or greater than a corresponding first flush threshold 172A. The dynamic heterogeneous flush control logic section 170 may cause the subset of write I/Os from the second temporary write holding buffer 160B to be written to the second non-volatile storage device 135B responsive to a number of flush requests associated with the first non-volatile storage device 135B being equal to or greater than a corresponding second flush threshold 172B. The dynamic heterogeneous flush control logic section 170 may cause the subset of write I/Os from the first temporary write holding buffer 160N to be written to the Nth non-volatile storage device 135N responsive to a number of flush requests associated with the Nth non-volatile storage device 135N being equal to or greater than a corresponding Nth flush threshold 172N, and so forth.

FIG. 2B is an example block diagram of the I/O interceptor logic section 120 of FIG. 1B, and multiple non-volatile write holding buffers (e.g., 162A, 162B, through 162N), each associated with a different kind of physical non-volatile storage device (e.g., 135A, 135B, through 135N), or a different connection thereto, in accordance with embodiments of the inventive concept. The non-volatile write holding buffers (e.g., 162A, 162B, through 162N) are similar to the temporary write holding buffers (e.g., 160A, 160B, through 160N) illustrated in FIG. 2A, with the notable difference that the non-volatile write holding buffers (e.g., 162A, 162B, through 162N) in FIG. 2B exist among the physical hardware devices 115, and are of a non-volatile nature. For example, the non-volatile write holding buffers (e.g., 162A, 162B, through 162N) can reside on one or more physical non-volatile storage devices, preferably fast ones such as PRAM, MRAM, or 3D XPoint devices.

The attributes of the non-volatile storage devices used to hold the buffers (e.g., 162A, 162B, through 162N) can be used to determine the dynamic flush thresholds (e.g., 172A, 172B, through 172N). For example, using non-volatile devices such as PRAM, MRAM, or 3D XPoint devices to incorporate the write holding buffers (e.g., 162A, 162B, through 162N), there is less risk of data loss due to power failure, and in some cases these devices have differing/higher capacity. Consequently, the write holding buffers (e.g., 162A, 162B, through 162N) can be flushed less often. Otherwise, the I/O interceptor logic section 120 can operate in a similar fashion to that described above with reference to FIG. 2A.

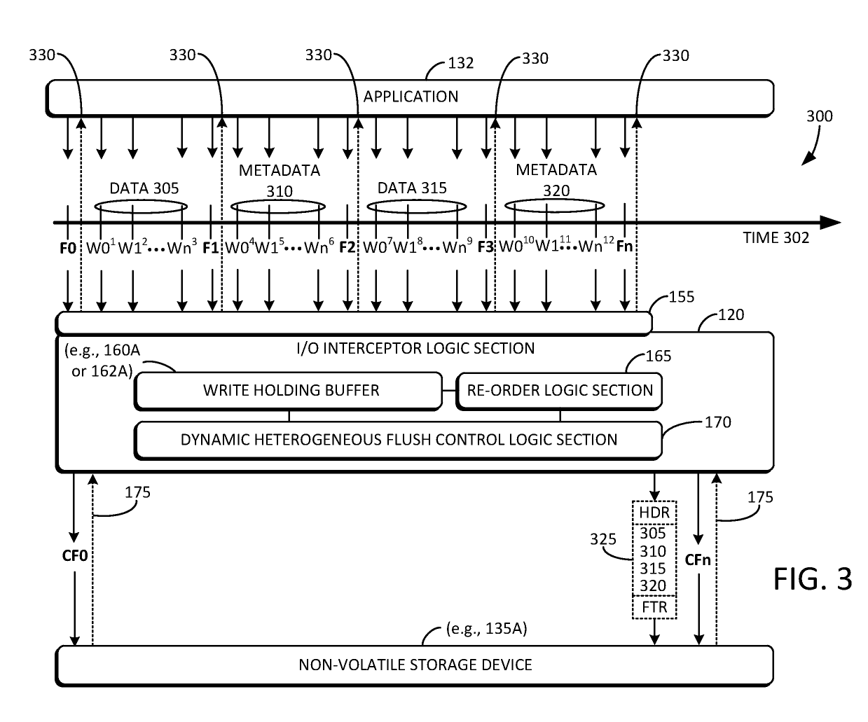

FIG. 3 is an example diagram 300 of various components of the system stack 100 of FIGS. 1A and 1B, including a series of events relative to time, as shown by timeline 302, in accordance with embodiments of the inventive concept.

For a given write holding buffer (e.g., 160A or 162A), the I/O interface 155 may intercept write I/Os including, for example, data write I/Os 305 (i.e., W0¹ through Wn³), metadata write I/Os 310 (i.e., W0⁴ through Wn⁶), data write I/Os 315 (i.e., W0⁷ through Wn⁹), metadata write I/Os 320 (i.e., W0¹⁰ through Wn¹²), and flush requests (e.g., F0 through Fn) from the application (e.g., 132). The write holding buffer (e.g., 160A or 162A) may receive the write I/Os from the I/O interface 155 and may store the write I/Os. If a read I/O is received from the application while the data is resident in the write holding buffer (e.g., 160A or 162A), the I/O interceptor logic section 120 may serve the read I/O request from the copy that is resident in the write holding buffer (e.g., 160A or 162A), or alternatively, from a re-mapped memory location, as further described below. The re-order logic section 165 may change an order of the write I/Os stored in each of the write holding buffers 160 or 162, as further described below. The re-order logic section 165 may convert random write I/Os to sequential write I/Os. The re-order logic section 165 may combine the re-ordered write I/Os (e.g., 305, 310, 315, and 320) into a combined write I/O (e.g., 325) for each of the write holding buffers (e.g., 160A or 162A).

The dynamic heterogeneous flush control logic section 170 may receive the flush requests (e.g., F0 through Fn) from the I/O interface 155. The dynamic heterogeneous flush control logic section 170 may communicate write I/O completion via corresponding completion messages (e.g., 330) of the write I/Os to the application (e.g., 132) without the write I/Os actually having been written to any of the one or more non-volatile storage devices 135. In other words, the dynamic heterogeneous flush control logic section 170 may substantially immediately reply to each flush request so that the application 132 may continue to send additional write I/Os without the need to wait for a corresponding flush request to actually be completed to one of the non-volatile storage devices 135, thereby significantly improving performance of the application 132. In other words, the dynamic heterogeneous flush control logic section 170 may communicate write I/O completion 330 of the write I/Os to the application 132 before the write I/Os have actually been written to any of the one or more non-volatile storage devices 135. Since the write I/O is stored in the write holding buffers 160 or 162, the dynamic heterogeneous flush control logic section 170 may cause at a later time the combined write I/O 325 to be actually written in a committed flush CFn to the corresponding non-volatile storage device 135. In other words, the dynamic heterogeneous flush control logic section 170 may implement a selective flush technique. The committed flush CFn may be a synchronous operation. Since the combined write I/O size is larger than the individual write I/Os, the storage performance is improved by reducing the overhead associated with each write I/O had they been sent to the non-volatile storage device independently. In addition, since the write I/Os may be completed from system memory, which has a significantly higher performance (i.e., high throughput and low latency) than the actual non-volatile storage devices, the performance of the application is significantly improved.

Moreover, since the committed flush CFn of the combined write I/O 325 occurs on or shortly following a flush boundary Fn (e.g., responsive to a number of flush requests being equal to or greater than a dynamic flush threshold), the data will maintain its consistency. Even in the event of a sudden power loss, the data will remain consistent on the non-volatile storage devices 135, although there may be loss of data. Loss of data is acceptable to applications, because the applications may read the data that is existent on the non-volatile storage device, and recover or otherwise roll back its state based on the stored data. But data inconsistency is usually not tolerated by applications and may cause unpredictable behavior, or even cause the application to become inoperable. Embodiments of the inventive concept ensure data consistency by accumulating write IOs between committed flushes (e.g., CFO and CFn), and then flushing the data in a combined write I/O to the non-volatile storage, as described herein.

The one or more non-volatile storage devices 135 may return a committed flush confirmation message (e.g., 175), which may be received by the I/O interceptor logic section 120, and used to confirm the completion of each committed flush transaction to the non-volatile storage, thereby providing synchronous committed flush operations. In other words, during a particular synchronous committed flush operation, other write IOs and non-committed flush requests that are not a part of the particular committed flush operation are accumulated and not permitted to be actually flushed to the non-volatile storage until a subsequent synchronous committed flush operation.

A sudden power loss may occur at any point in time, and the data will remain consistent. In other words, there will always be metadata paired with data on the one or more non-volatile storage devices 135. In other words, there may never be a situation in which metadata exists on the one or more non-volatile storage devices 135 without corresponding data. Consequently, in accordance with embodiments of the inventive concept, data consistency is maintained while significantly boosting performance of the application and storage stack.

In addition, a window of opportunity for re-ordering write IOs is expanded because what are typically committed flush requests may be transformed into non-committed flush requests. Typically, write IOs may only be re-ordered between flush boundaries (e.g., between F0 and F1). However, in accordance with embodiments of the inventive concept, typical flush requests are transformed into non-committed flush requests, and write IOs may be re-ordered across the non-committed flush boundaries (e.g., between F0 and Fn and across F1, F2, and F3) because the actual committed flushes (e.g., CFO and CFn) occur on an expanded time scale. In other words, the number of write IOs is greater between two committed flushes (e.g., CFO and CFn) than the number of write IOs between two non-committed flush requests (e.g., F0 and F1, F1 and F2, or F2 and F3, etc.), which occur more frequently and on a shorter time scale. By expanding the window of opportunity to re-order IOs, additional performance increases may be achieved because the IOs may be ordered in such a way that they are more efficient to write to the non-volatile storage devices, and are also more efficient to write in that they are grouped into a single combined (i.e., larger) write IO.

The dynamic heterogeneous flush control logic section 170 may cause the combined write I/O 325 to be written to the corresponding non-volatile storage devices 135 responsive to a number of flush requests (e.g., F), F1, F2, F3, and Fn) from among the flush requests being equal to or greater than a dynamic flush threshold. The dynamic flush threshold may be an integer of 2, 3, 4, 5, 8, 10, 16, 20, 32, 64, 100, and so forth, and may be variable or otherwise change based on the particular non-volatile storage device (e.g., 135A) to which the write I/O 325 is being sent. The dynamic flush threshold, which controls how many flushes to accumulate before causing a committed flush CFn may be configurable for each kind of non-volatile storage device (e.g., 135A), and may be predefined (e.g., predetermined and set) prior to operation. In some embodiments, the dynamic flush threshold may be a configurable setting, which may be modified by a user or system administrator. In some embodiments, the dynamic flush threshold may be automatically determined by the dynamic heterogeneous flush control logic section 170 based on characteristics of the underlying physical non-volatile storage devices.

Alternatively or in addition, the dynamic heterogeneous flush control logic section 170 may cause the committed flush CFn to write the combined write I/O 325 to the one or more non-volatile storage devices 135 responsive to a threshold amount of data being accumulated. In other words, when a threshold amount of data is reached, the dynamic heterogeneous flush control logic section 170 may cause the committed flush CFn at the next flush request. The threshold amount of data may vary depending on the characteristics of the underlying physical non-volatile storage devices. Alternatively or in addition, the dynamic heterogeneous flush control logic section 170 may cause the committed flush CFn to write the combined write I/O 325 to the one or more non-volatile storage devices 135 responsive to an expiration of a predefined period of time. The predefined period of time may be, for example, on the order of seconds, such as 5 seconds, 10 seconds, 30 seconds, 60 seconds, and so forth. The threshold period of time may vary depending on the characteristics of the underlying physical non-volatile storage devices. This reduces the chances of data loss in the event of a sudden power loss, while boosting performance and maintaining data consistency. Alternatively or in addition, the dynamic heterogeneous flush control logic section 170 may cause the committed flush CFn to write the combined write I/O 325 to the one or more non-volatile storage devices 135 responsive to a first criteria that the threshold amount of data being accumulated, and then subsequently, responsive to a second criteria that the dynamic flush threshold is satisfied. In other words, the committed flush CFn may occur when either or both criteria are satisfied.

The I/O interface 155 of the I/O interceptor logic section 120 may receive a first subset of data write I/Os (e.g., 305), a first flush request (e.g., F1), a first subset of metadata write I/Os (e.g., 310), a second flush request (e.g., F2), a second subset of data write I/Os (e.g., 315), a third flush request (e.g., F3), a second subset of metadata write I/Os (e.g., 320), and a fourth flush request (e.g., Fn). The re-order logic section 165 may change the order of write I/Os within the first subset of the data write I/Os 305, the first subset of the metadata write I/Os 310, the second subset of the data write I/Os 315, and the second subset of the metadata write I/Os 320. In other words, the re-order logic section 165 may change the order of the individual write I/Os within each subset and/or change the order of the individual write I/Os across the various subsets. The re-order logic section 165 may combine the first subset of the data write I/Os 305, the first subset of the metadata write I/Os 310, the second subset of the data write I/Os 315, and the second subset of the metadata write I/Os 320 into the combined write I/O 325. The re-order logic section 165 may insert or otherwise attach a header HDR and footer FTR to the combined write I/O 325, as further described below.

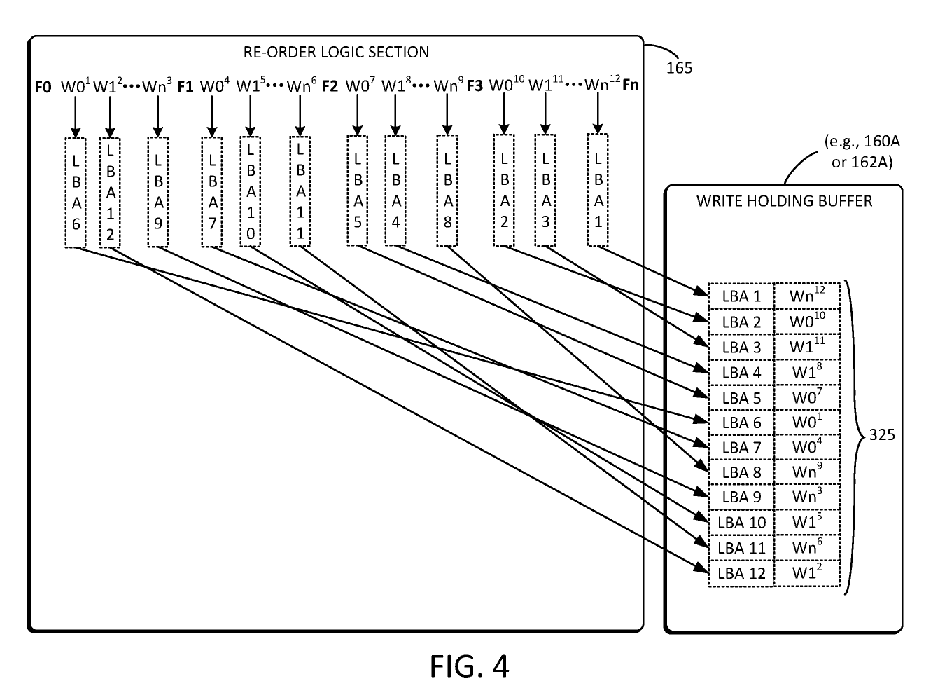

FIG. 4 is an example diagram of the re-order logic section 165 of the I/O interceptor logic section 120 (of FIGS. 1A and 1B), and a write holding buffer (e.g., 160A or 162A) of the I/O interceptor logic section 120 (of FIGS. 1A and 1B) in accordance with embodiments of the inventive concept. As explained above, the re-order logic section 165 may change the order of the individual write I/Os within each subset and/or change the order of the individual write I/Os across the various subsets. In this example embodiment, write I/O W0¹ corresponds with logical block address (LBA) 6, write I/O W1² corresponds with LBA 12, write I/O Wn³ corresponds with LBA 9, write I/O W0⁴ corresponds with LBA 7, write I/O W1⁵ corresponds with LBA 10, write I/O Wn⁶ corresponds with LBA 11, write I/O W0⁷ corresponds with LBA 5, write I/O W1⁸ corresponds with LBA 4, write I/O Wn⁹ corresponds with LBA 8, write I/O W0¹⁰ corresponds with LBA 2, write I/O W1¹¹ corresponds with LBA 3, and write I/O Wn¹² corresponds with LBA 1. The various LBAs correspond with logical block addresses in the one or more non-volatile storage devices 135 to which the various corresponding write IOs are destined to be stored.

The re-order logic section 165 may change the order of the various write I/Os so that they may be arranged in a combined write I/O 325 in such a manner that each of LBAs (e.g., LBA 1, LBA 2, LBA 3, etc.) associated with a corresponding one of the write I/Os (e.g., Wn¹², W0¹⁰, W1¹¹ and so forth) of the combined write I/O 325 is ordered in an ascending or descending arrangement. For example, the write I/Os may originally arrive in the following order having the following associated LBAs: W0¹/LBA 6, W1²/LBA 12, Wn³/LBA 9, W0⁴/LBA 7, W1⁵/LBA 10, Wn⁶/LBA 11, W0⁷/LBA 5, W1⁸/LBA 4, Wn⁹/LBA 8, W0¹⁰/LBA 2, W1¹¹/LBA 3, and Wn¹²/LBA 1. It will be understood that these LBA values are by way of example and not limitation as other LBAs not specifically described herein may fall within the various embodiments of the inventive concept described herein. The re-order logic section 165 may change the order of the individual write I/Os within the write holding buffer 160 or 162 to have the following order: Wn¹²/LBA 1, W0¹⁰/LBA 2, W1¹¹/LBA 3, W1⁸/LBA 4, W0⁷/LBA 5, W0¹/LBA 6, W0⁴/LBA 7, Wn⁹/LBA 8, Wn³/LBA 9, W1⁵/LBA 10, Wn⁶/LBA 11, and W1²/LBA 12, as shown in FIG. 4. In this manner, the LBAs may be arranged in ascending or descending order so that the writing of the combined write I/O 325 to the one or more non-volatile storage devices 135 (of FIGS. 1A and 1B) is more efficient.

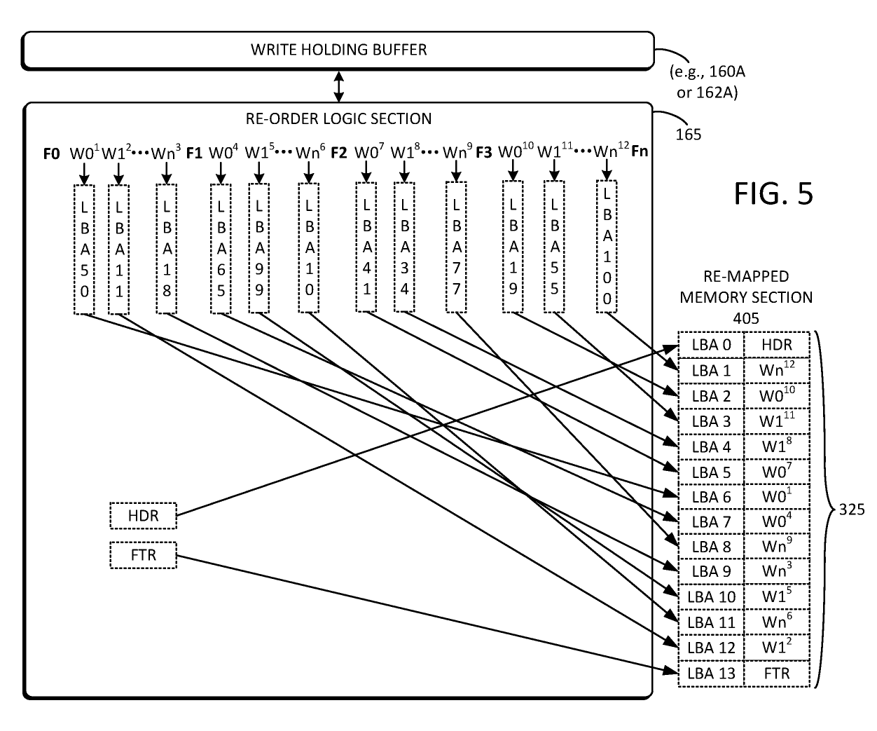

FIG. 5 an example diagram of the re-order logic section 165 of the I/O interceptor logic section 120 (of FIGS. 1A and 1B), and a re-mapped memory section 405. The re-mapped memory section 405 may be allocated from system memory and/or within the I/O interceptor logic section 120 in accordance with embodiments of the inventive concept. It is common that the LBAs may not be simply re-ordered into an ascending, descending, and/or contiguous group because of the wide disparity of the LBAs. For example, the write I/Os may originally arrive in the following order having the following associated LBAs: W0¹/LBA 50, W1²/LBA 11, Wn³/LBA 18, W0⁴/LBA 65, W1⁵/LBA 99, Wn⁶/LBA 10, W0⁷/LBA 41, W1⁸/LBA 34, Wn⁹/LBA 77, W0¹⁰/LBA 19, W1¹¹/LBA 55, and Wn¹²/LBA 100. It will be understood that these LBA values are by way of example and not limitation as other LBAs not specifically described herein may fall within the various embodiments of the inventive concept described herein.

The re-order logic section 165 may change the order of the individual write I/Os by pre-pending a header HDR and appending a footer FTR, and re-mapping the individual write I/Os to the re-mapped memory section 405. In other words, the re-order logic section 165 may copy the individual write I/Os, a header HDR, and a footer FTR, to form the combined write I/O 325, such that each of a plurality of logical block addresses (LBAs) (e.g., 1, 2, 3, etc.) associated with a corresponding one of the plurality of write I/Os (e.g., Wn¹², W0¹⁰, W1¹¹, etc.) of the combined write I/O 325 may be arranged in ascending or descending order, and such that each of the plurality of write I/Os (e.g., Wn¹², W0¹⁰, W1¹¹, etc.) of the combined write I/O 325 are physically contiguous in the re-mapped memory section 405 to another of the plurality of write I/OS (e.g., Wn¹², W0¹⁰, W1¹¹, etc.) of the combined write I/O 325. The re-order logic section 165 may convert random write I/Os to sequential write I/Os.

For example, the combined write I/O 325 within the re-mapped memory section 405 may have the individual write I/Os re-mapped and arranged in the following order: HDR/LBA 0, Wn¹²/LBA 1, W0¹⁰/LBA 2, W1¹¹/LBA 3, W1⁸/LBA 4, W0⁷/LBA 5, W0¹/LBA 6, W0⁴/LBA 7, Wn⁹/LBA 8, Wn³/LBA 9, W1⁵/LBA 10, Wn⁶/LBA 11, W1²/LBA 12, and FTR/LBA 13, as shown in FIG. 5. In this manner, the LBAs may be arranged in contiguous fashion so that the writing of the combined write I/O 325 to the one or more non-volatile storage devices 135 (of FIGS. 1A and 1B) is more efficient.

In some embodiments, the re-mapped memory section 405 may be known only to the I/O interceptor logic section 120. The header HDR and/or footer FTR may include re-mapping translation information. Alternatively or in addition, the header HDR and/or footer FTR may include information that indicates that the combined write I/O 325 is valid. Any combined write I/O 325 having a header HDR but no footer FTR on the one or more non-volatile storage devices 135 may be considered invalid. Such a scenario may be caused by a sudden power loss during the committed flush operation CFn. In this scenario, the combined write I/O 325 may be determined to be invalid and may be discarded. When a valid combined write I/O 325 is later retrieved from the one or more non-volatile storage devices 135 to be read in a read I/O operation, the re-mapping translation information stored in the header HDR and/or the footer FTR may be used by the I/O interceptor logic section 120 to provide expected data and/or associated expected LBA information to the application 132.

The dynamic heterogeneous flush control logic section 170 may cause the physically contiguous combined write I/O 325 to be written to the corresponding non-volatile storage devices 135 responsive to a number of flush requests being equal to or greater than the dynamic flush threshold, or other criteria, as further described below.

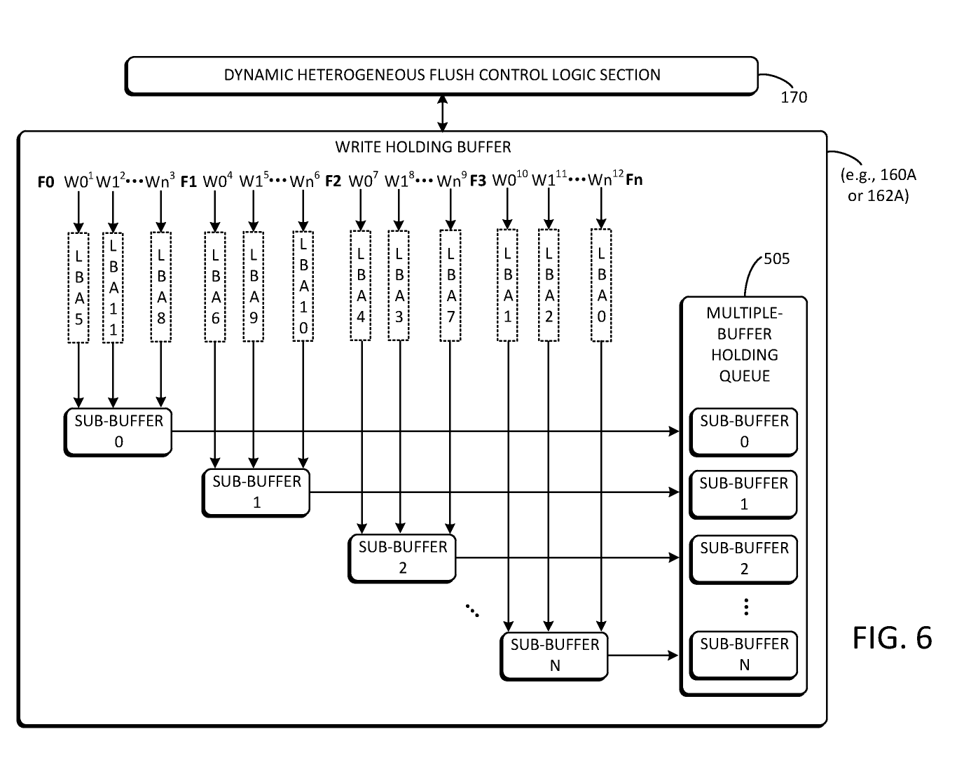

FIG. 6 is an example diagram of the dynamic heterogeneous flush control logic section 170 of the I/O interceptor logic section 120 (of FIGS. 1A and 1B), and a write holding buffer (e.g., 160A or 162A) of the I/O interceptor logic 120 section in accordance with embodiments of the inventive concept.

The re-order logic section 165 need not be included in the I/O interceptor logic 120. Rather, in this embodiment, the dynamic heterogeneous flush control logic section 170 may manage a plurality of write holding sub-buffers, such as Sub-Buffer 0, Sub-Buffer 1, Sub-Buffer 2, and Sub-Buffer N, as shown in FIG. 6. The write holding sub-buffers may receive the write I/Os (e.g., W0¹, W1², Wn³, etc.) from the I/O interface 155 (of FIGS. 1A and 1B), and may store the write I/Os. A multiple-buffer holding queue 505 may hold the write holding sub-buffers.

The dynamic heterogeneous flush control logic section 170 may receive the plurality of flush requests (F0, F1, F2, etc.) from the I/O interface 155 (of FIGS. 1A and 1B), and may communicate write I/O completion (e.g., 330 of FIG. 3) of the write I/Os (e.g., W0¹, W1², Wn³, etc.) to the application (e.g., 132 of FIGS. 1A and 1B) without the write I/Os having been written to the one or more non-volatile storage devices 135 (of FIGS. 1A and 1B). For example, the dynamic heterogeneous flush control logic section 170 may communicate write I/O completion of the write I/Os to the application 132 before the write I/Os have actually been written to any of the non-volatile storage devices 135.

The dynamic heterogeneous flush control logic section 170 may cause the first subset of the data write I/Os (e.g., 305 of FIG. 3) to be stored in the first write holding sub-buffer Sub-Buffer 0, the first subset of the metadata write I/Os (e.g., 310 of FIG. 3) to be stored in the second write holding sub-buffer Sub-Buffer 1, the second subset of the data write I/Os (e.g., 315 of FIG. 3) to be stored in the third write holding sub-buffer Sub-Buffer 3, and the second subset of the metadata write I/Os (e.g., 320 of FIG. 3) to be stored in the fourth write holding sub-buffer Sub-Buffer N.

The dynamic heterogeneous flush control logic section 170 may cause the multiple-buffer holding queue 505 to empty the write I/Os from the write holding sub-buffers (e.g., Sub-Buffer 0, Sub-Buffer 1, Sub-Buffer 2, and Sub-Buffer N) to the corresponding non-volatile storage device (e.g., 135A) responsive to a number of flush requests being equal to or greater than a dynamic flush threshold, and in the order received. In this embodiment, the re-ordering and re-mapping of the write I/Os is avoided, and no additional headers or footers are needed. On the other hand, the performance increase is not as pronounced as the embodiments described above because the LBAs are sent to the one or more non-volatile storage devices 135 in an essentially random fashion. In the event of a sudden power loss, data consistency is still maintained because the order in which the application intended to write the data is preserved.

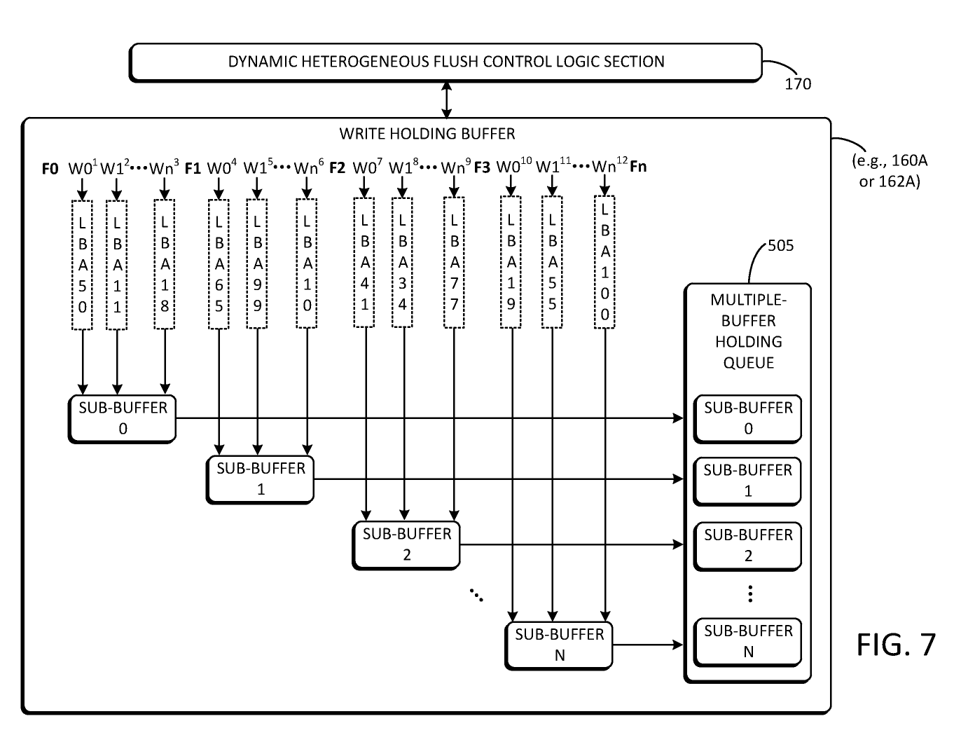

FIG. 7 is another example diagram of an dynamic heterogeneous flush control logic section 170 of the I/O interceptor logic section 120 (of FIGS. 1A and 1B), and a write holding buffer (e.g., 160A or 162A) of the I/O interceptor logic section in accordance with embodiments of the inventive concept. FIG. 7 is similar to that of FIG. 6 with the notable difference that the LBAs have a wide disparity. Nevertheless, the operation of this embodiment is the same or similar to that described with reference to FIG. 6 above, and therefore, a detailed description is not repeated. It will be understood, however, that the embodiment shown in FIG. 7 having a wide disparity in the LBA values falls within the inventive concept, and may be implemented in a fashion that is the same as or similar to that described with reference to FIG. 6 above.

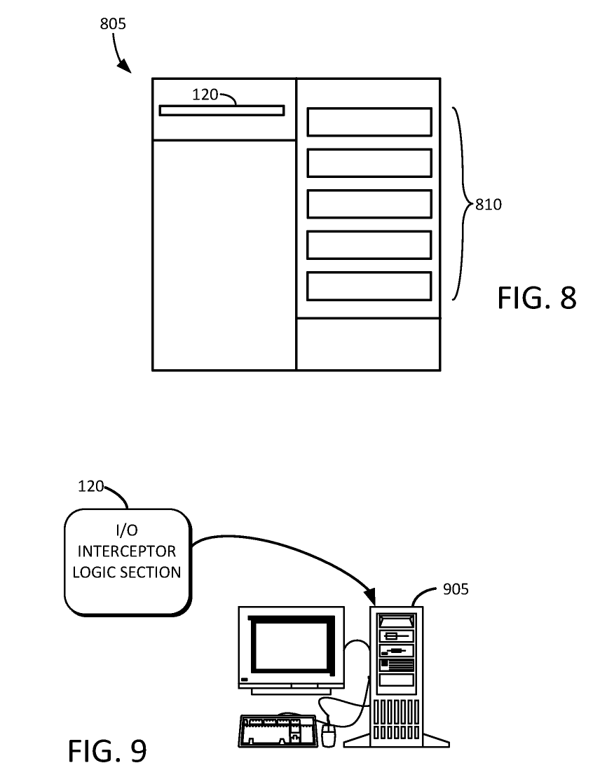

FIG. 8 is a schematic diagram of a server rack 805 including the I/O interceptor logic section 120 of FIGS. 1A and 1B, in accordance with embodiments of the inventive concept. The interceptor logic section 120 may intercept and process I/Os, as described in detail above, for one or more severs 810 located in the server rack 805. It will be understood that any suitable device within the server rack 805 that uses non-volatile storage may include or otherwise operate with the I/O interceptor logic section 120, as described in detail above.

FIG. 9 is a schematic diagram of a computer server 905 including the I/O interceptor logic section 120 of FIGS. 1A and 1B, in accordance with embodiments of the inventive concept. The interceptor logic section 120 of the server 905 may intercept and process I/Os, as described in detail above, for the sever 905. It will be understood that any suitable device that uses non-volatile storage may include or otherwise operate with the I/O interceptor logic section 120, as described in detail above.

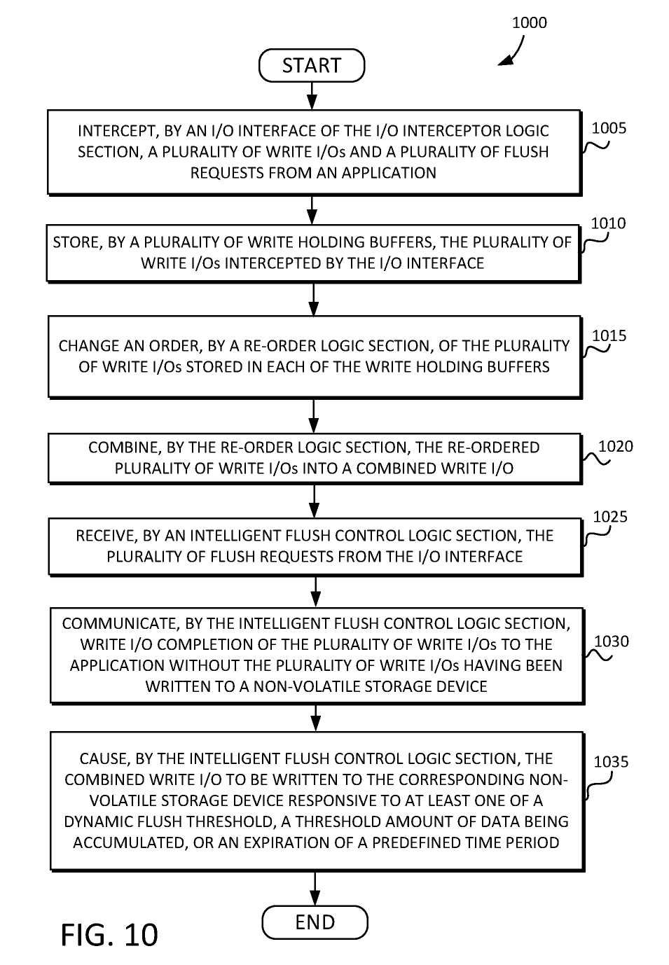

FIG. 10 is a flow diagram 1000 illustrating a technique for intercepting I/Os from an application using an I/O interceptor logic section (e.g., 120 of FIGS. 1A and 1B) in accordance with embodiments of the inventive concept. The technique begins at 1005 where a plurality of write I/Os and a plurality of flush requests may be intercepted, by an I/O interface of the I/O interceptor logic section, from an application. At 1010, the plurality of write I/Os received by the I/O interface may be stored, by a plurality of write holding buffers. Each of the write holding buffers may be associated with or otherwise coupled to a corresponding non-volatile storage device. At 1015, re-order logic section may change an order of the plurality of write I/Os stored in each of the write holding buffers. At 1020, the re-order logic section may combine the re-ordered plurality of write I/Os into a combined write I/O for each of the write holding buffers.

At 1025, a dynamic heterogeneous flush control logic section may receive the plurality of flush requests from the I/O interface. At 1030, the dynamic heterogeneous flush control logic section may communicate write I/O completion of the plurality of write I/Os to the application without the plurality of write I/Os having been written to a non-volatile storage device. In other words, the dynamic heterogeneous flush control logic section may communicate write I/O completion of the write I/Os to the application before the write I/Os have actually been written to any of the one or more non-volatile storage devices 135. At 1035, the dynamic heterogeneous flush control logic section may cause the combined write I/O to be written to the corresponding non-volatile storage device responsive to a number of flush requests from among the plurality of flush requests being equal to or greater than a flush threshold, a threshold amount of data being accumulated, and/or an expiration of a predefined time period.

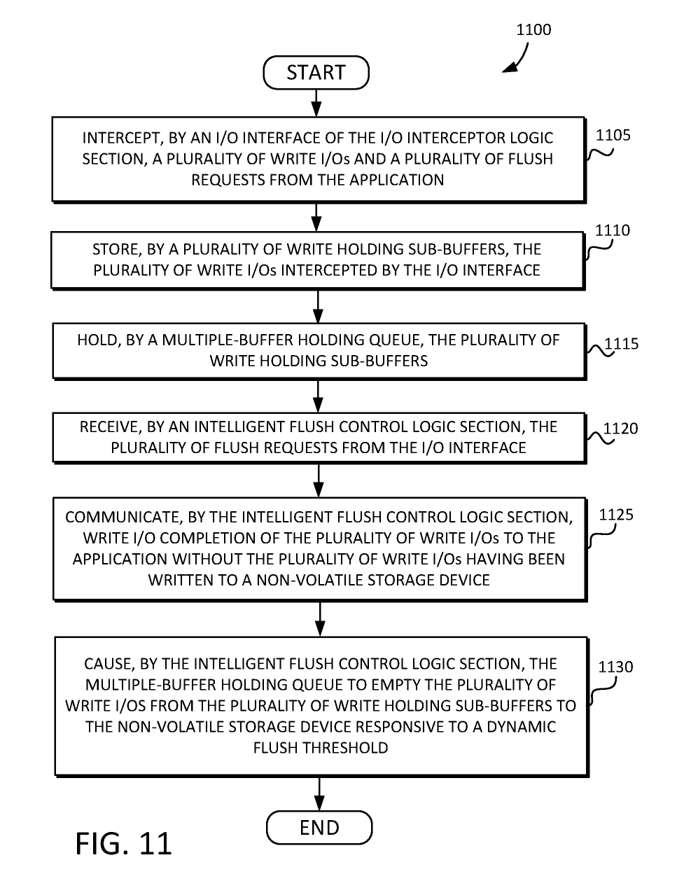

FIG. 11 is a flow diagram 1100 illustrating another technique for intercepting I/Os from an application using an I/O interceptor logic section (e.g., 120 of FIGS. 1A and 1B) in accordance with embodiments of the inventive concept. The technique begins at 1105 where a plurality of write I/Os and a plurality of flush requests may be received, by an I/O interface of the I/O interceptor logic section, from an application. At 1110, the plurality of write I/Os intercepted by the I/O interface may be stored, by a plurality of write holding sub-buffers. At 1115, the multiple-buffer holding queue may hold the plurality of write holding sub-buffers.

At 1120, the dynamic heterogeneous flush control logic section may receive the plurality of flush requests from the I/O interface. At 1125, the dynamic heterogeneous flush control logic section may communicate write I/O completion of the plurality of write I/Os to the application without the plurality of write I/Os having been written to a non-volatile storage device. In other words, the dynamic heterogeneous flush control logic section may communicate write I/O completion of the write I/Os to the application before the write I/Os have actually been written to any of the one or more non-volatile storage devices 135. At 1130, the dynamic heterogeneous flush control logic section may cause the multiple-buffer holding queue to empty the plurality of write I/Os from the plurality of write holding sub-buffers to the non-volatile storage device responsive to at least one of a number of flush requests being equal to or greater than a dynamic flush threshold, a threshold amount of data being accumulated, or an expiration of a predefined time period.

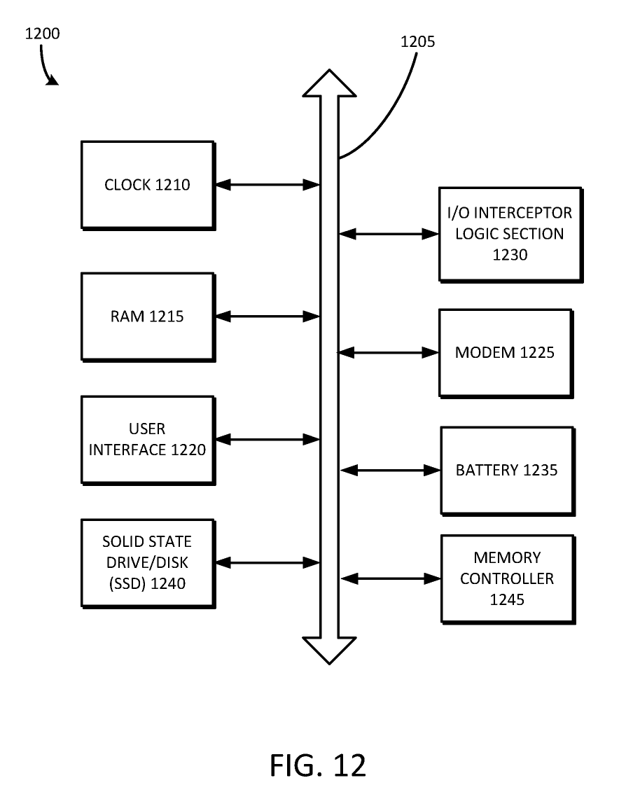

FIG. 12 is a block diagram of a computing system 1200 including an I/O interceptor logic section 1230 according to embodiments of the inventive concept as disclosed herein. Referring to FIG. 12, the computing system 1200 may also include a clock 1210, a random access memory (RAM) 1215, a user interface 1220, a modem 1225 such as a baseband chipset, a solid state drive/disk (SSD) 1240, a memory controller 1245, and/or a battery 1235, any or all of which may be electrically coupled to a system bus 1205. The I/O interceptor logic section 1230 may correspond to 120 described in detail above, and as set forth herein, and may also be electrically coupled to the system bus 1205.

If the computing system 1200 is a mobile device, the battery 1235 may power the computing system 1200, and battery drain may be reduced by implementation of the embodiments of the inventive concept described herein due more efficient writing of data to storage. Although not shown in FIG. 12, the computing system 1200 may further include an application chipset, a camera image processor (CIS), a mobile DRAM, and the like.

In example embodiments, the computing system 1200 may be used as computer, computer server, server rack, portable computer, Ultra Mobile PC (UMPC), workstation, net-book, PDA, web tablet, wireless phone, mobile phone, smart phone, e-book, PMP (portable multimedia player), digital camera, digital audio recorder/player, digital picture/video recorder/player, portable game machine, navigation system, black box, 3-dimensional television, a device capable of transmitting and receiving information at a wireless circumstance, one of various electronic devices constituting home network, one of various electronic devices constituting computer network, one of various electronic devices constituting a telematics network, RFID, or one of various electronic devices constituting a computing system.

The following discussion is intended to provide a brief, general description of a suitable machine or machines in which certain aspects of the inventive concept may be implemented. Typically, the machine or machines include a system bus to which is attached processors, memory, e.g., random access memory (RAM), read-only memory (ROM), or other state preserving medium, storage devices, a video interface, and input/output interface ports. The machine or machines may be controlled, at least in part, by input from conventional input devices, such as keyboards, mice, etc., as well as by directives received from another machine, interaction with a virtual reality (VR) environment, biometric feedback, or other input signal. As used herein, the term “machine” is intended to broadly encompass a single machine, a virtual machine, or a system of communicatively coupled machines, virtual machines, or devices operating together. Exemplary machines include computing devices such as personal computers, workstations, servers, portable computers, handheld devices, telephones, tablets, etc., as well as transportation devices, such as private or public transportation, e.g., automobiles, trains, cabs, etc.

The machine or machines may include embedded controllers, such as programmable or non-programmable logic devices or arrays, Application Specific Integrated Circuits (ASICs), embedded computers, smart cards, and the like. The machine or machines may utilize one or more connections to one or more remote machines, such as through a network interface, modem, or other communicative coupling. Machines may be interconnected by way of a physical and/or logical network, such as an intranet, the Internet, local area networks, wide area networks, etc. One skilled in the art will appreciate that network communication may utilize various wired and/or wireless short range or long range carriers and protocols, including radio frequency (RF), satellite, microwave, Institute of Electrical and Electronics Engineers (IEEE) 545.11, Bluetooth®, optical, infrared, cable, laser, etc.

Embodiments of the present inventive concept may be described by reference to or in conjunction with associated data including functions, procedures, data structures, application programs, etc. which when accessed by a machine results in the machine performing tasks or defining abstract data types or low-level hardware contexts. Associated data may be stored in, for example, the volatile and/or non-volatile memory, e.g., RAM, ROM, etc., or in other storage devices and their associated storage media, including hard-drives, floppy-disks, optical storage, tapes, flash memory, memory sticks, digital video disks, biological storage, etc. Associated data may be delivered over transmission environments, including the physical and/or logical network, in the form of packets, serial data, parallel data, propagated signals, etc., and may be used in a compressed or encrypted format. Associated data may be used in a distributed environment, and stored locally and/or remotely for machine access.

Having described and illustrated the principles of the inventive concept with reference to illustrated embodiments, it will be recognized that the illustrated embodiments may be modified in arrangement and detail without departing from such principles, and may be combined in any desired manner. And although the foregoing discussion has focused on particular embodiments, other configurations are contemplated. In particular, even though expressions such as “according to an embodiment of the inventive concept” or the like are used herein, these phrases are meant to generally reference embodiment possibilities, and are not intended to limit the inventive concept to particular embodiment configurations. As used herein, these terms may reference the same or different embodiments that are combinable into other embodiments.

Embodiments of the inventive concept may include a non-transitory machine-readable medium comprising instructions executable by one or more processors, the instructions comprising instructions to perform the elements of the inventive concepts as described herein.

The foregoing illustrative embodiments are not to be construed as limiting the inventive concept thereof. Although a few embodiments have been described, those skilled in the art will readily appreciate that many modifications are possible to those embodiments without materially departing from the novel teachings and advantages of the present disclosure. Accordingly, all such modifications are intended to be included within the scope of this inventive concept as defined in the claims.

What is claimed is:

1. An input/output (I/O) interceptor logic section, comprising:
an I/O interface communicatively coupled with a storage stack and configured to intercept a plurality of write I/Os and a plurality of flush requests from an application;
a plurality of write holding buffers each associated with a corresponding non-volatile storage device from among a plurality non-volatile storage devices, wherein each of the write holding buffers is configured to receive a subset of the plurality of write I/Os from the I/O interface and to store the subset of write I/Os; and
a dynamic heterogeneous flush control logic section configured to receive the plurality of flush requests from the I/O interface, to communicate write I/O completion of the plurality of write I/Os to the application without the plurality of write I/Os having been written from the plurality of write holding buffers to the corresponding non-volatile storage device from among the plurality of non-volatile storage devices.

2. The I/O interceptor logic section of claim 1, wherein each of the plurality non-volatile storage devices is of a different kind.

3. The I/O interceptor logic section of claim 2, wherein the dynamic heterogeneous flush control logic section includes a plurality of flush thresholds each associated with a corresponding one of the non-volatile storage devices.

4. The I/O interceptor logic section of claim 3, wherein each of the flush thresholds is different relative to each other, and based on the kind of the corresponding one of the non-volatile storage devices.

5. The I/O interceptor logic section of claim 4, wherein the dynamic heterogeneous flush control logic section is configured to cause the write I/Os from each of the write holding buffers to be written to the corresponding non-volatile storage device responsive to a number of flush requests from among the plurality of flush requests being equal to or greater than a corresponding flush threshold from among the plurality of flush thresholds.

6. The I/O interceptor logic section of claim 2, wherein:
the plurality of write holding buffers includes a first write holding buffer and a second write holding buffer;
the plurality of non-volatile storage devices includes a first non-volatile storage device and a second non-volatile storage device;
the first write holding buffer is associated with the first non-volatile storage device;
the second write holding buffer is associated with the second non-volatile storage device;
the dynamic heterogeneous flush control logic section is configured to cause the subset of write I/Os from the first write holding buffer to be written to the first non-volatile storage device responsive to a number of flush requests associated with the first non-volatile storage device being equal to or greater than a corresponding first flush threshold from among the plurality of flush thresholds; and
the dynamic heterogeneous flush control logic section is configured to cause the subset of write I/Os from the second write holding buffer to be written to the second non-volatile storage device responsive to a number of flush requests associated with the second non-volatile storage device being equal to or greater than a corresponding second flush threshold from among the plurality of flush thresholds.

7. The I/O interceptor logic section of claim 6, wherein:
the plurality of write holding buffers includes a third write holding buffer;
the plurality of non-volatile storage devices includes a third non-volatile storage device;
the third write holding buffer is associated with the third non-volatile storage device; and
the dynamic heterogeneous flush control logic section is configured to cause the subset of write I/Os from the third write holding buffer to be written to the third non-volatile storage device responsive to a number of flush requests associated with the third non-volatile storage device being equal to or greater than a corresponding third flush threshold from among the plurality of flush thresholds.

8. The I/O interceptor logic section of claim 1, wherein each of the plurality of write holding buffers is stored on a corresponding non-volatile storage device from among a second plurality non-volatile storage devices.

9. The I/O interceptor logic section of claim 1, further comprising:
a re-order logic section communicatively coupled to the plurality of write holding buffers and configured to change an order of the subset of write I/Os stored in each of the write holding buffers, and to combine the re-ordered write I/Os into a combined write I/O for each of the write holding buffers,
wherein the dynamic heterogeneous flush control logic section is configured to cause the combined write I/O for each of the write holding buffers to be written to the corresponding non-volatile storage device from among the plurality non-volatile storage devices responsive to a number of flush requests being equal to or greater than a dynamic flush threshold.

10. The I/O interceptor logic section of claim 9, wherein the re-order logic section is configured to convert random write I/Os from among the plurality of write I/Os to sequential write I/Os.

11. The I/O interceptor logic section of claim 9, wherein the dynamic flush threshold is dependent on a kind of the corresponding non-volatile storage device to which the combined write I/O is sent.

12. The I/O interceptor logic section of claim 1, wherein for a given write holding buffer from among the plurality of write holding buffers:
the I/O interface is configured to intercept a first subset of data write I/Os from among the plurality of write I/Os, a first flush request from among the plurality of flush requests, a first subset of metadata write I/Os from among the plurality of write I/Os, a second flush request from among the plurality of flush requests, a second subset of data write I/Os from among the plurality of write I/Os, a third flush request from among the plurality of flush requests, a second subset of metadata write I/Os from among the plurality of write I/Os, and a fourth flush request from among the plurality of flush requests.

13. The I/O interceptor logic section of claim 12, wherein the re-order logic section is configured to:
change the order of the plurality of write I/Os included in the first subset of the data write I/Os, the first subset of the metadata write I/Os, the second subset of the data write I/Os, and the second subset of the metadata write I/Os so that logical block addresses (LBAs) associated with the plurality of write I/Os are arranged in ascending or descending order; and
combine the re-ordered plurality of write I/Os included in the first subset of the data write I/Os, the first subset of the metadata write I/Os, the second subset of the data write I/Os, and the second subset of the metadata write I/Os into a combined write I/O.

14. The I/O interceptor logic section of claim 12, wherein the re-order logic section is configured to:
copy the plurality of write I/Os, a header, and a footer, to a re-mapped memory section to form a combined write I/O, such that each of a plurality of logical block addresses (LBAs) associated with a corresponding one of the plurality of write I/Os of the combined write I/O are arranged in ascending or descending order, and such that each of the plurality of write I/Os of the combined write I/O are physically contiguous in the re-mapped memory section to another of the plurality of write I/Os of the combined write I/O.

15. The I/O interceptor logic section of claim 12, wherein the dynamic heterogeneous flush control logic section is configured to cause the physically contiguous combined write I/O to be written to the corresponding non-volatile storage device from among the plurality of non-volatile storage devices responsive to the fourth flush request from among the plurality of flush requests being equal to or greater than a flush threshold associated with the given write holding buffer.

16. An input/output (I/O) interceptor logic section, comprising:
an I/O interface communicatively coupled with a storage stack and configured to intercept a plurality of write I/Os and a plurality of flush requests from an application;
a plurality of write holding buffers configured to receive the plurality of write I/Os from the I/O interface and to store the plurality of write I/Os;
each of the write holding buffers including a multiple-buffer holding queue configured to hold a plurality of write holding sub-buffers; and
a dynamic heterogeneous flush control logic section configured to receive the plurality of flush requests from the I/O interface, to communicate write I/O completion of the plurality of write I/Os to the application without the plurality of write I/Os having been written to a plurality of non-volatile storage devices, and to cause the multiple-buffer holding queue to empty the plurality of write I/Os from the plurality of write holding sub-buffers to the plurality of non-volatile storage devices responsive to a number of flush requests from among the plurality of flush requests being equal to or greater than a dynamic flush threshold.

17. The I/O interceptor logic section of claim 16, further comprising:
a first write holding buffer from among the plurality of write holding buffers associated with a first non-volatile storage device from among the plurality of non-volatile storage devices;
a second write holding buffer from among the plurality of write holding buffers associated with a second non-volatile storage device from among the plurality of non-volatile storage devices;
a third write holding buffer from among the plurality of write holding buffers associated with a third non-volatile storage device from among the plurality of non-volatile storage devices; and
a fourth write holding buffer from among the plurality of write holding buffers associated with a fourth non-volatile storage device from among the plurality of non-volatile storage devices.

18. The I/O interceptor logic section of claim 17, wherein the dynamic heterogeneous flush control logic section is configured to:
cause the first subset of the data write I/Os to be stored in the first write holding buffer and flushed to the first non-volatile storage device responsive to a first flush threshold;
cause the first subset of the metadata write I/Os to be stored in the second write holding buffer and flushed to the second non-volatile storage device responsive to a second flush threshold;
cause the second subset of the data write I/Os to be stored in the third write holding buffer and flushed to the third non-volatile storage device responsive to a third flush threshold, and
cause the second subset of the metadata write I/Os to be stored in the fourth write holding buffer and flushed to the fourth non-volatile storage device responsive to a fourth flush threshold.

19. The I/O interceptor logic section of claim 16, wherein each of the plurality of write holding buffers is stored on a corresponding non-volatile storage device from among a second plurality non-volatile storage devices.

20. A computer-implemented method for intercepting input/outputs (I/Os) from an application using an I/O interceptor logic section, the method comprising:
intercepting, by an I/O interface of the I/O interceptor logic section, a plurality of write I/Os and a plurality of flush requests from the application;
storing, by a plurality of write holding buffers, the plurality of write I/Os intercepted by the I/O interface;
receiving, by a dynamic heterogeneous flush control logic section, the plurality of flush requests from the I/O interface;
communicating, by the dynamic heterogeneous flush control logic section, write I/O completion of the plurality of write I/Os to the application without the plurality of write I/Os having been written to a plurality of non-volatile storage devices, wherein each of the write holding buffers is associated with a corresponding one of the non-volatile storage devices; and
causing, by the dynamic heterogeneous flush control logic section, the write I/Os to be written to the plurality of non-volatile storage devices responsive to a number of flush requests from among the plurality of flush requests being equal to or greater than a dynamic flush threshold.

21. The computer-implemented method of claim 20, further comprising:
intercepting, by the I/O interface, a first subset of data write I/Os from among the plurality of write I/Os, a first flush request from among the plurality of flush requests, a first subset of metadata write I/Os from among the plurality of write I/Os, a second flush request from among the plurality of flush requests, a second subset of data write I/Os from among the plurality of write I/Os, a third flush request from among the plurality of flush requests, a second subset of metadata write I/Os from among the plurality of write I/Os, and a fourth flush request from among the plurality of flush requests.

22. The computer-implemented method of claim 21, further comprising:
causing, by the dynamic heterogeneous flush control logic section, the write I/Os to be written to the plurality of non-volatile storage devices responsive to a number of flush requests from among the plurality of flush requests being equal to or greater than the dynamic flush threshold.
